(19) United States
(12) Patent Application Publication
(10) Pub. No.: US 2012/0198961 A1
(43) Pub. Date: Aug. 9, 2012

(54) Housing cover

(75) Inventor: Armin Diez, Lenningen (DE)

(73) Assignee: ElringKlinger AG

(21) Appl. No.: 13/374,889

(22) Filed: Jan. 20, 2012

Related U.S. Application Data
(63) Continuation of application No. 11/330,463, filed on Jan. 12, 2006, now abandoned.

(30) Foreign Application Priority Data
Jan. 25, 2005 (DE) 10 2005 003 414.4

(51) Int. Cl. F16H 57/031; B32B 3/24

(52) U.S. Cl. 74/606 R; 428/131

(57) ABSTRACT

To provide a housing cover for fixing to a housing which is simple to produce and to fit, it is proposed that the housing cover is configured as a sheet metal formed part, that the housing cover is provided with a plurality of fastening means through-apertures and with a sealing bead, which comprises an elastomeric material, and that when the housing cover is in a rest state prior to tightening the housing cover against the housing by means of the fastening means, at least one contact region portion of the inside of the housing cover which faces the housing when the housing cover is in the fitted state, said contact region portion being located between two fastening means through-apertures and carrying a portion of the sealing bead, projects, at least in a section thereof, over the inside edges of the two adjacent fastening means through-apertures.

### RELATED APPLICATION

This application is a continuation of application Ser. No. 11/330,463 filed Jan. 12, 2006, which claims priority of German application No. 10 2005 003 414.4 filed Jan. 25, 2005.

The present disclosure relates to the subject matter disclosed in German patent application No. 10 2005 003 414.4 of Jan. 25, 2005, the entire specification of which is incorporated herein by reference.

### FIELD OF THE DISCLOSURE

The present invention relates to a housing cover for fixing to a housing, in particular to a gear housing or a steering gear housing.

### BACKGROUND

Housing covers for closing apertures on a gear housing or on a steering gear housing, as known from the prior art, are formed as aluminum cast parts, which are machined mechanically and are fitted to the relevant housing together with a seal configured separately from the cast part. The production and fitting of such known housing covers are expensive.

### SUMMARY OF THE INVENTION

The present invention is therefore based on the object of providing a housing cover of the type mentioned at the outset, which is simple to produce and fit.

This object is achieved according to the invention in a housing cover of the type mentioned at the outset in that the housing cover is configured as a sheet metal formed part, in that the housing cover is provided with a plurality of fastening means through-apertures and with a sealing bead, which comprises an elastomeric material and in that, when the housing cover is in a rest state prior to tightening the housing cover against the housing by means of the fastening means, at least one contact region portion of the inner side of the housing cover which faces the housing when the housing cover is in the fitted state, said contact region portion being located between two fastening means through-apertures and carrying a portion of the sealing bead, projects, at least in a section thereof, over the inside edges of the two adjacent fastening means through-apertures.

Since the housing cover according to the invention is configured as a sheet metal formed part with an integrated seal in the form of the sealing bead provided on the housing cover, the housing cover according to the invention can be produced in a very economic manner, for example in a follow-on composite tool, from a sheet metal starting material.

Since the seal is integrated in the form of the sealing bead on the housing cover, the fitting of the housing cover is also simplified, as the number of parts to be fitted is reduced.

Since the contact region portion of the inside of the housing cover, located between two fastening through-apertures, projects at least in sections over the inside edges of the two adjacent fastening means through-apertures, it is achieved, that, during its fitting, the housing cover firstly rests with these projecting regions of the contact region portion on the housing to be closed, before the fastening means are tightened, and consequently the inside edges of the two adjacent fastening means through-apertures also then come to rest on the housing to be closed. Owing to the topography of the contact region of the housing cover designed in this way, with the housing to be closed, the variation in the surface pressure, with which the housing cover is braced against the housing to be closed is at least partially compensated in the longitudinal direction of the sealing bead, which variation is caused by the varying spacings from the respective closest fastening means, and therefore uniform resting of the contact region and, in particular, the sealing bead on the housing to be closed is achieved at each position of the contact region or the sealing bead.

This topography of the contact region may be produced, in particular by a shoulder portioning and/or stamping process on the housing cover during the production thereof.

In a preferred configuration of the invention, it is provided that the contact region portion, viewed from the inside of the housing cover, is substantially convex.

In a configuration of the invention it is provided that the housing cover has a substantially constant material thickness along the contact region portion.

As an alternative to this, it may also be provided, that, along the contact region portion, the housing cover has a varying material thickness in the longitudinal direction of the contact region portion. A variation of this type of the material thickness of the housing cover in the contact region may be produced, for example by a stamping process on a housing cover originally having a constant material thickness.

The region of the outside of the housing cover opposing the contact region portion, which faces away from the housing to be closed when the housing cover is in the fitted state, may be substantially flat.

The projection (x) of the contact region portion over the inside edges of the two adjacent fastening means through-apertures may vary in the longitudinal direction of the contact region portion.

It is preferably provided that the projection (x) of the contact region portion over the inside edges of the two adjacent fastening means through-apertures is greatest approximately in the centre between the two adjacent fastening means through-apertures.

The variation of the projection (x) of the contact region portion over the inside edges of the two adjacent fastening means through-apertures may be established, in particular taking into account an internal pressure acting on the housing cover and/or taking into account external forces, which are transmitted to the housing cover via a coupling, for example a holder arranged on the outside of the housing cover, in such a way that the variation in the internal pressure forces or the external forces are substantially compensated in the longitudinal direction of the contact region portion, at least in sections.

In a preferred configuration of the invention, it is also provided that the housing cover is provided with an impressed groove, in which the sealing bead is arranged.

Furthermore, the housing cover may be provided, to reinforce it, with a reinforcement element impressed into the housing cover.

This reinforcement element may be configured, in particular, as a stiffening corrugation.

The stiffening corrugation may, in this case have any desired cross-section, in particular may be configured as a full corrugation or half corrugation.

If the housing cover is provided with a groove impressed into the housing cover, in which the sealing bead is arranged, the reinforcement element preferably extends at least in sections, substantially parallel to this groove.

The sealing bead is preferably connected with a substance-to-substance bond in terms of material, to the base plate of the housing cover.

The integral connection in terms of material, may, in particular, be produced in that the sealing bead is provided by application of a free-flowing precursor material, for example by means of a dispenser nozzle, and subsequent vulcanising thereof or by means of a pattern printing method, in particular by means of a screen printing method, onto the housing cover.

The precursor material used for the sealing bead may, in particular be a one-component silicone material or a two-component silicone material

Basically, the metallic base plate of the housing cover may be formed from any metallic material.

In a preferred configuration of the embodiment it is provided that the housing cover is configured as a sheet metal formed part made from aluminum or from an aluminum alloy.

Further features and advantages of the invention are the subject of the following description and the graphic view of embodiments.

### BRIEF DESCRIPTION OF THE DRAWINGS

FIG. 1 shows a schematic perspective view of a housing cover, viewed from the inside of the housing cover facing the housing, in the fitted state;

FIG. 2 shows a schematic cross-section through the housing cover from FIG. 1, along the line 2-2 in FIG. 1;

FIG. 3 shows an enlarged view of the region I from FIG. 2;

FIG. 4 shows a schematic longitudinal section through the housing cover from FIG. 1, in the rest state prior to the housing cover being fitted, along the line 4-4 in FIG. 1;

FIG. 5 shows a schematic cross-section through the housing cover from FIG. 1 along the line 5-5 in FIG. 1, with fastening screws penetrating the fastening means through-apertures of the housing cover;

FIG. 6 shows a schematic longitudinal section corresponding to FIG. 4 through a second embodiment of a housing cover, in which the material thickness of the housing cover varies in contact region portions located between the fastening means through-apertures depending on the spacing from the closest fastening means through-aperture;

FIG. 7 shows a schematic cross-section corresponding to FIG. 5, through the second embodiment of a housing cover, with fastening screws penetrating the fastening means through-apertures; and

FIG. 8 shows a section-wise schematic perspective view of an edge region of a third embodiment of a housing cover, in which a sealing bead arranged on the housing cover annularly surrounds the fastening means through-apertures.

The same or functionally equivalent elements are designated by the same reference numerals in all the figures.

### DETAILED DESCRIPTION OF THE INVENTION

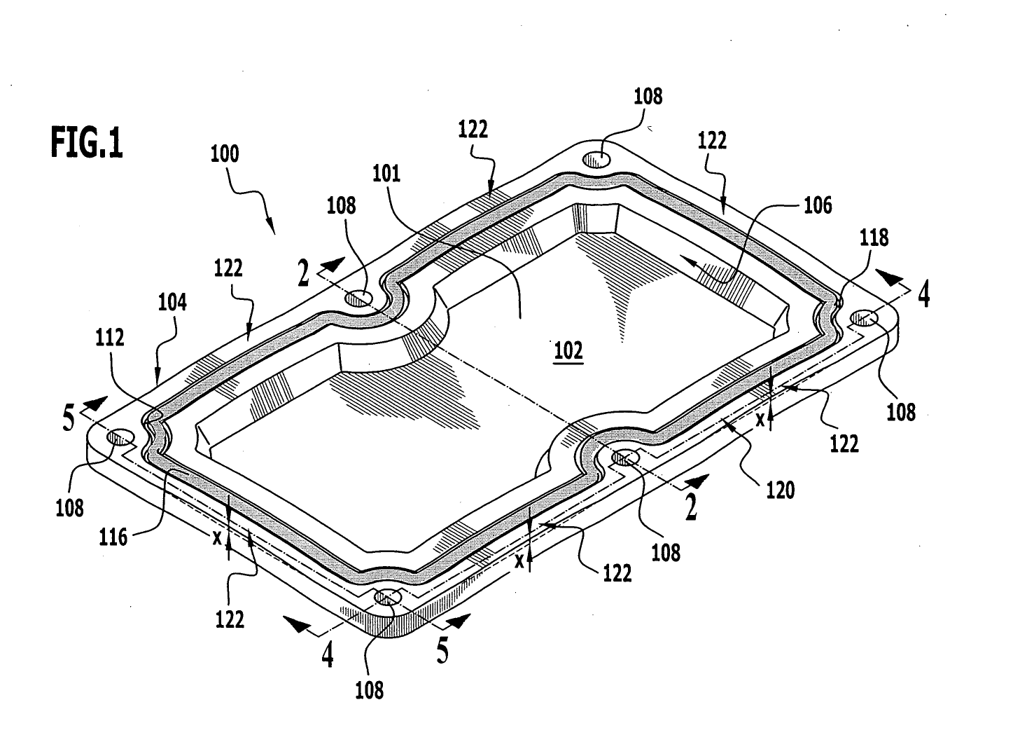

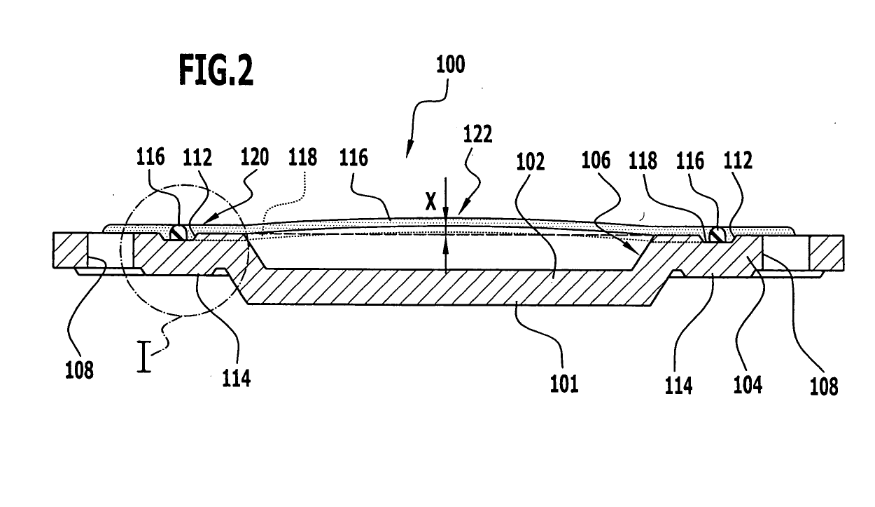

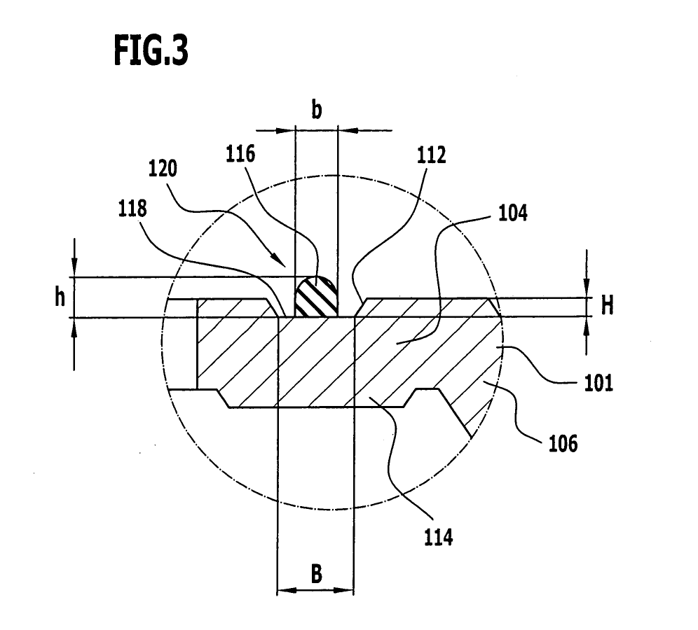

A housing cover shown in FIGS. 1 to 5 and designated as a whole by 100 is provided for closing a housing aperture on a gear housing (not shown) or on a steering gear housing.

The housing cover 100 is substantially rectangular and comprises a metallic base plate 101 with a substantially flat central region 102, which is surrounded by a peripheral edge region 104, which is connected to the central region 102 of the housing cover 100 via an annularly extending shoulder portion 106.

The edge region 104 projects over the central region 102 in the direction pointing toward the housing to be closed when the housing cover 100 is in the fitted state.

The edge region 104 is provided with a plurality of, for example six, fastening means through-apertures 108, which run consecutively at a spacing from one another along the periphery of the housing cover 100.

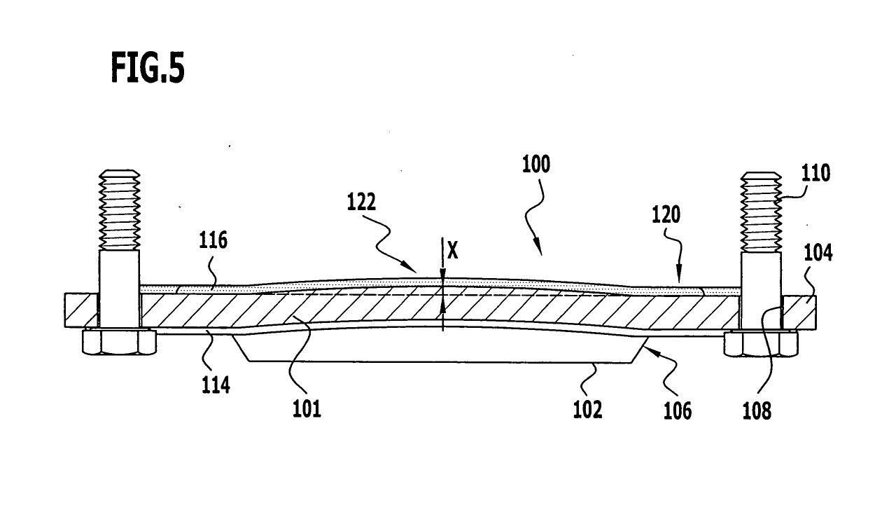

These fastening means through-apertures 108 are used, during fitting of the housing cover 100 to the housing to be closed, to receive the shanks of fastening screws 110 (see FIG. 5), which extend through the fastening means through-apertures 108 and are screwed into corresponding internal threads of threaded holes of the housing to be closed by their external threads.

The edge region 104 of the housing cover 100 is also provided with an impressed groove 112, which is configured on the inside of the edge region 104 facing the housing to be closed when the housing cover 100 is in the fitted state, substantially parallel to the shoulder portion 106 and in the form of a ring around the central region 102 of the housing cover 100, the groove 112 extending, on the one hand, between the shoulder portion 106 and the fastening means through-apertures 108, on the other hand.

As the groove 112 is formed by stamping in the edge region 104 of the housing cover 100, an annular projection 114 formed on the outside of the edge region 104 corresponds to the groove 112 extending on the inside of the edge region 104.

Provided for fluid-tight sealing between the housing cover 100 and the housing to be closed is a sealing bead 116, which is arranged on the groove base 118 of the groove 112 and extends inside the groove 112 around the central region 102 of the housing cover 100.

The sealing bead 116 is formed from an elastomer material, for example from a silicone material and may be applied, for example, by application into the groove 112 by means of a dispenser or by a screen printing method.

The width b of the sealing bead 116, i.e. the extent thereof transverse to the longitudinal direction of the groove 112 is, for example about 1.5 mm, with a total width B of the groove 112 of, for example about 2.5 mm.

The height h of the sealing bead 116 above the groove base 118 is, for example about 120 μm+/−40 μm, with a groove depth H of, for example about 50 μM, so the sealing bead 116, when the housing cover 100 is in the rest state, projects beyond the regions adjoining the groove 112, of the housing cover 100 in the direction pointing toward the housing, in the fitted state.

The groove 112 with the sealing bead 116 and the regions of the edge region 104 of the housing 100 adjoining the groove 112 together form a contact region 120 of the housing cover 100, with which the housing cover 100, in the fitted state, rests on the housing to be closed.

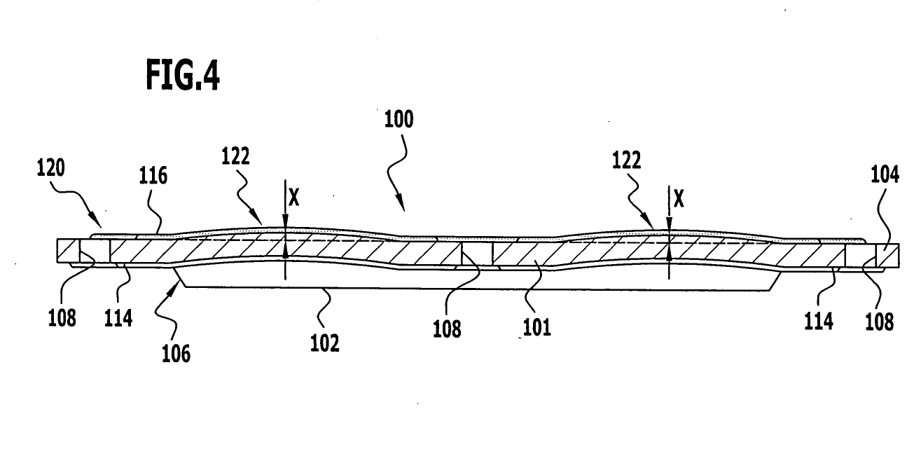

In order to ensure that the housing cover 100 rests uniformly on the housing to be closed, the housing cover 100 is provided, in the contact region 120, with a topography, i.e. the contact region portions 122 of the housing cover 100, located between two respective fastening means through-apertures 108, are configured such that, when the housing cover 100 is in the rest state, i.e. before the housing cover 100 is tightened against the housing to be closed by means of the fastening screws 110, they project over the inside edges of the respectively adjacent fastening means through-apertures 108 in the direction pointing toward the housing to be closed, when the housing cover 100 is in the fitted state, as is shown schematically in the longitudinal section of FIG. 4.

It is achieved in this manner that, during its fitting, the housing cover 100 firstly rests with the central regions of the contact regions portions 122 located approximately in the centre between two respective fastening means through-apertures 108, on the housing to be closed, before the fastening screws 110 are tightened, and consequently the regions surrounding the inside edges of the fastening means through-apertures 108, of the housing cover 100 also come to rest on the housing to be closed.

Owing to the topography of the contact region 120 of the housing cover 100 thus formed, the variation in the surface pressure, with which the housing cover 100 is braced against the housing to be closed, is at least partially compensated in the longitudinal direction of the sealing bead 116, which variation is caused by the varying spacings from the respective closest fastening screw 110, and therefore uniform resting of the contact region 120 and in particular of the sealing bead 116 on the housing to be closed is achieved at each location of the contact region 120 or of the sealing bead 116.

This topography of the contact region 120 is produced by a shoulder portioning and/or stamping process on the housing cover 100, the material thickness of the housing cover 100 along the contact region 120 remaining substantially constant.

The contact region 120 is bent in such a way that it is convexly curved in the contact region portions 122 located between two respective adjacent fastening means through-apertures 108, viewed from the inside of the housing cover 100.

To produce the above-described housing cover 100, the procedure is as follows:

In a follow-on composite tool, the housing cover 100 is punched out with the desired outer contour and the fastening means through-apertures 108 from a metal sheet of a metallic material, in particular from an aluminum metal sheet.

Furthermore, the housing cover 100 is provided in the follow-on composite tool by means of suitable forming tools, with the impressed groove 112, with the shoulder portion 106 and with the above-described topography of the contact region 120.

The sealing bead 116 is then produced from the elastomer material on the groove base 118 of the groove 112 by a screen printing method.

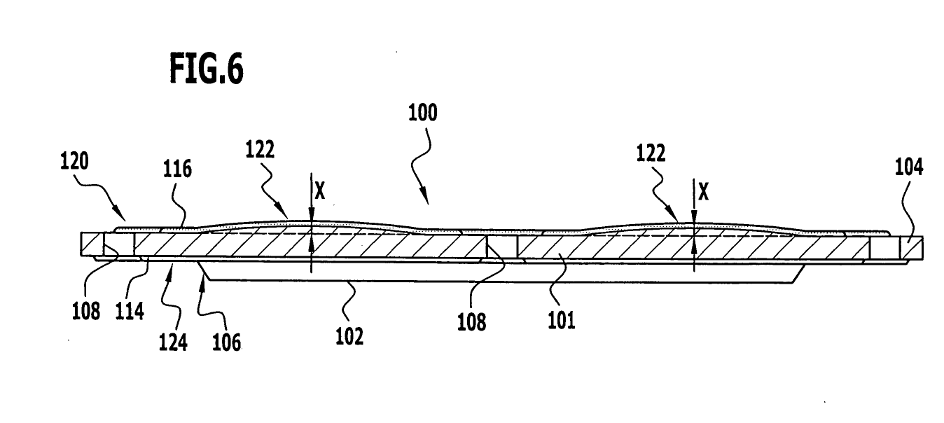

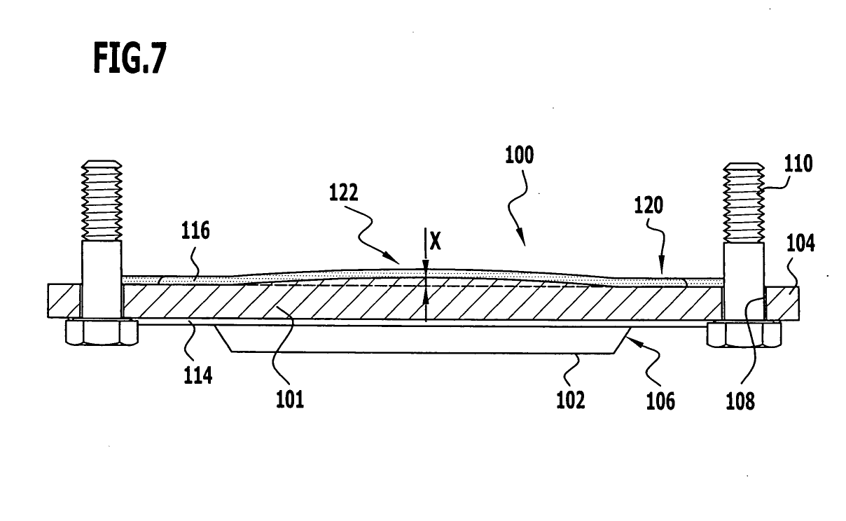

A second embodiment of a housing cover 100 shown in FIGS. 6 and 7 differs from the first embodiment described above merely in that the material thickness of the housing cover 100 along the contact region portions 122 is not substantially constant, but varies in the longitudinal direction of the contact region portions 122 as a function of the spacing from the respective closest fastening means through-aperture 108.

In particular, the housing cover 100 in this embodiment is configured such that the material thickness of the housing cover 100 is greatest approximately in the centre between two fastening means through-apertures 108 following one another in the peripheral direction of the housing cover 100 and tapers from there toward the fastening means through-apertures 108.

This course of the material thickness of the housing cover 100 in the contact region 120 can be produced, for example, by a stamping process on a housing cover 100 originally having a constant material thickness.

The region 124 of the outside of the housing cover 100 opposing the contact region 120 may be substantially flat.

Otherwise, the second embodiment of a housing cover 100 shown in FIGS. 6 and 7 coincides with the first embodiment with regard to structure, function and mode of production, and the above description thereof is referred to in this respect.

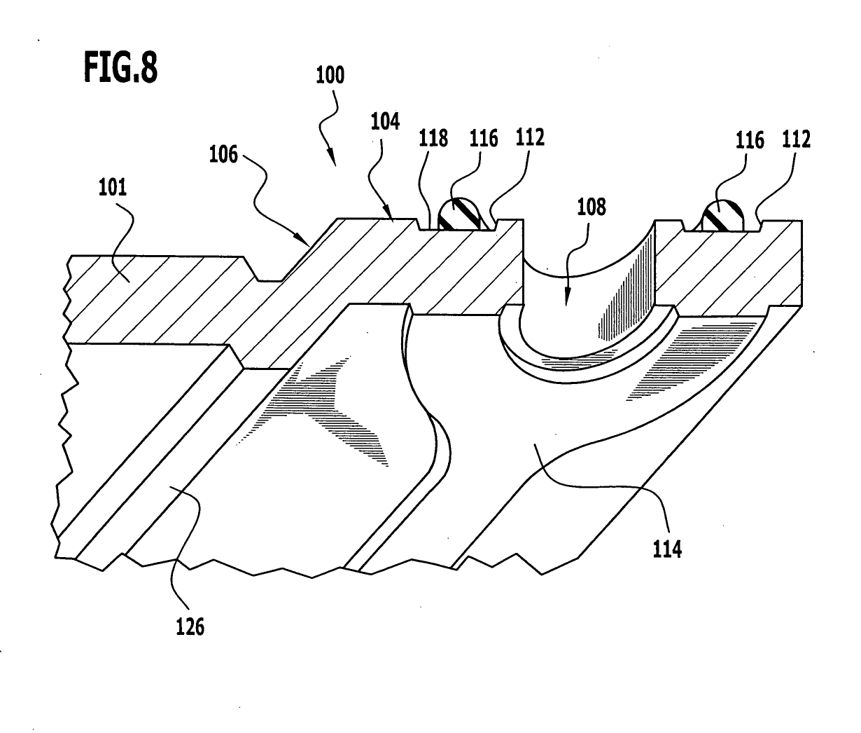

A third embodiment of a housing cover 100 shown sectionally in FIG. 8 differs from the two embodiments described above in that the groove 112 and the sealing bead 116 do not extend throughout between the fastening means through-apertures 108, on the one hand, and the shoulder portion 106 on the other hand, but branch (viewed in the peripheral direction of the housing cover 100) in each case, before a fastening means through-aperture 108 and run together again after passing the fastening means through-aperture 108 (both to the left and right of the fastening means through-aperture 108), so each fastening means through-aperture 108 is enclosed in ring-like manner by the groove 112 and also by the sealing bead 116.

It is thus achieved that the region of each fastening means through-aperture 108 is sealed in a fluid-tight manner both toward the central region 102 of the housing cover 100 and also toward the outer edge of the housing cover 100 by the sealing bead 116.

Furthermore, the third embodiment of a housing cover 100 is provided with a stiffening corrugation 126 which reinforces the housing cover 100 and is configured on the inner edge of the shoulder portion 106, parallel thereto, which edge faces the central region 102.

Otherwise, the third embodiment of a housing cover 100 shown in FIG. 8 coincides with the two first embodiments with regard to structure, function and mode of production, and reference is made to the above description thereof, in this respect.

1. Housing cover for fixing to a housing, wherein the housing cover is configured as a sheet metal formed part, wherein the housing cover is provided with a plurality of fastening means through-apertures and with a sealing bead, which comprises an elastomeric material, wherein the housing cover includes at least one contact region portion located between two fastening means through-apertures and carrying a portion of the sealing bead and further projects, at least in a section thereof, over the inside edges of the two adjacent fastening means through-apertures when the housing cover is in a rest state prior to tightening the housing cover against the housing in a fitted state thereof by means of the fastening means, said at least one contact region portion of the inside of the housing cover facing the housing when the housing cover is in said fitted state, wherein the housing cover is provided with an impressed groove in which the sealing bead is received, the impressed groove extending along the longitudinal direction of the sealing bead,
wherein the sealing bead is arranged on a groove base of the groove and projects, when the housing cover is in the rest state, beyond regions of the housing cover adjoining the groove in the direction pointing toward the housing, in the fitted state,
wherein the sealing bead is connected by a substance-to-substance bond to a base plate of the housing cover,
wherein the base plate is made of metal, and
wherein the width of the sealing bead is smaller than the width of the groove.

2. Housing cover according to claim 1, wherein the contact region portion, viewed from the inside of the housing cover, is substantially convex.

3. Housing cover according to claim 1, wherein the housing cover has a substantially constant material thickness along the contact region portion.

4. Housing cover according to claim 1, wherein, along the contact region portion, the housing cover has a material thickness which varies in the longitudinal direction of the contact region portion.

5. Housing cover according to claim 1, wherein the region of the outside of the housing cover opposing the contact region portion is substantially flat.

6. Housing cover according to claim 1, wherein the projection of the contact region portion over the inside edges of the two adjacent fastening means through-apertures varies in the longitudinal direction of the contact region portion.

7. Housing cover according to claim 6, wherein the projection of the contact region portion over the inside edges of the two adjacent fastening means through-apertures is greatest approximately in the center between the two adjacent fastening means through-apertures.

8. (canceled)

9. Housing cover according to claim 1, wherein the housing cover is provided with a reinforcement element impressed in the housing cover.

10. Housing cover according to claim 9, wherein the reinforcement element is configured as a stiffening corrugation.

11. Housing cover according to claim 9, wherein the reinforcement element extends, at least in sections, substantially parallel to said groove impressed in the housing cover, in which groove the sealing bead is arranged.

12. (canceled)

13. Housing cover according to claim 12, wherein the sealing bead is provided by application by means of a dispenser and/or by means of a pattern printing method.

14. Housing cover according to claim 1, wherein the housing cover is configured as a sheet metal formed part made of aluminum or of an aluminum alloy.

15. Housing cover of claim 1 that is fixed to a gear housing.

16. Housing cover of claim 1 that is fixed to a steering gear housing.

17. Housing cover according to claim 13 wherein the sealing bead is applied by a screen printing method.

18. Housing cover according to claim 1, wherein the sealing bead branches before at least one fastening means through-aperture and runs together again after passing the fastening means through-aperture so that the fastening means through-aperture is enclosed about its periphery by the sealing bead.

19. Housing cover according to claim 1, wherein said inside edges of the two adjacent fastening means through-apertures come to rest on the housing when the housing cover is in said fitted state.
